(19) United States
(12) Patent Application Publication
(10) Pub. No.: US 2008/0139021 A1
(43) Pub. Date: Jun. 12, 2008

(54) Relay connector

(75) Inventors: Hisashi Suzuki, Tokyo (JP); Chikara Miura, Tokyo (JP)

Correspondence Address: MORGAN LEWIS & BOCKIUS LLP, 1111 PENNSYLVANIA AVENUE NW, WASHINGTON, DC, 20004, US

(73) Assignee: Yokowo Co., Ltd.

(21) Appl. No.: 11/987,991

(22) Filed: Dec. 6, 2007

(30) Foreign Application Priority Data
Dec. 8, 2006 (JP) P2006-332240

(51) Int. Cl. H01R 4/66

(52) U.S. Cl. 439/92

(57) ABSTRACT

A second operating lever is provided on a first operating lever so as to swing by means of a swing shaft. A board GND block is fixed to the first operating lever. An outer shell GND block is connected to the second operating lever and is movable in an approaching and separating direction in association with a swing motion of the second operating lever. A resilient member resiliently urges in a direction of bringing the outer shell GND block into contact with the board GND block. The outer shell GND block is formed with a through hole into which an insulating pipe is inserted. A probe is inserted into the insulating pipe and is brought into contact with a distal end of the core conductor. The outer shell GND of the coaxial connector is fixed to the outer shell GND block. A pressure member is provided on the outer shell GND block. The board GND block is electrically connected to the outer shell GND block.

### BACKGROUND OF THE INVENTION

The present invention relates to a relay connector for electrically connecting a core conductor of a coaxial connector to a terminal electrode provided on a surface of a board, and for electrically connecting an outer shell GND of the coaxial connector to a GND electrode provided on a back face of the board.

In designing and producing a high frequency circuit board or the like, it is necessary to evaluate its performance in a process of designing thereof. For this purpose, a core conductor of a coaxial connector is electrically connected to a terminal electrode which is provided at an end of a surface of the board, and an outer shell GND of the coaxial connector is electrically connected to a GND electrode which is provided at an end of a back face of the board, whereby performance is evaluated based on high frequency signals obtained from the terminal electrode. A structure for electrically connecting the related art coaxial connector to the board will be briefly described referring to FIGS. 9 and 10. FIG. 9 is a view showing the structure for electrically connecting the related art coaxial connectors to the board. FIG. 10 is an exploded perspective view showing a state before the related art coaxial connectors are connected to the board. In FIGS. 9 and 10, core conductors 14a of the coaxial connectors (SMA type connectors, for example) 14 are electrically connected to terminal electrodes 12 which are provided at an end of a surface of a board 10 by soldering, and outer shell GNDs 14b of the coaxial connectors 14 are electrically connected to a GND electrode 16 which is provided at an end of a back face of the board 10.

In the structure as shown in FIGS. 9 and 10, when the coaxial connectors 14 are electrically connected to the board, soldering work is annoying. Moreover, when the coaxial connectors 14 are detached from the board, work for melting the solder is also annoying. Besides, on occasion of soldering and melting the solder, heat is applied to a dielectric member, which is resin material and constitutes a component of the coaxial connector 14, thereby causing such anxiety that the dielectric member may be deformed and/or changed in electrical performance. Therefore, such a board under the conventional structure is not economically favorable in view of the limited number of repetitive use.

Meanwhile, a related art of electrically connecting the coaxial connector to the board without soldering is disclosed in U.S. Pat. No. 5,017,865. Briefly describing, this related art is constructed by fixing an outer shell GND of a coaxial connector to a block formed of electrically conductive material, by projecting a core conductor of the coaxial connector from one face of this block in an electrically insulated state, and further, by providing a moving member which is formed of electrically conductive material and capable of moving along the one face of this block. In a state where a board is mounted on the moving member, this moving member is moved toward the core conductor to bring the core conductor into contact with the terminal electrode provided at the end of the surface of the board, thereby obtaining electrical connection. At the same time, because the GND electrode provided at the end of the back face of the board is mounted on the moving member, the outer shell GND obtains electrical connection by way of this moving member and the block. Therefore, it is possible to electrically connect the coaxial connector to the board without soldering.

In the related art disclosed in the above mentioned U.S. Pat. No. 5,017,865, a structure for moving the moving member carrying the board toward the core conductor of the coaxial connector is complicated, and an apparatus is considerably large as a whole. It is desired to provide an apparatus which is more compact, and can attach and detach the coaxial connector to and from the board more easily.

### SUMMARY

It is therefore an object of the invention to provide a relay connector which is compact, and at the same time, can electrically connect a coaxial connector to a board by simple operation, and can easily detach the coaxial connector from the board.

In order to achieve the object, according to the invention, there is provided a relay connector for electrically connecting a core conductor of a coaxial connector to a terminal electrode provided at an end of a surface of a board, and for electrically connecting an outer shell GND of the coaxial connector to a GND electrode provided at an end of a back face of the board, the relay connector comprising:

a first operating lever;

a second operating lever, provided on the first operating lever so as to swing by means of a first swing shaft;

a board GND block, comprised of electrically conductive material, and fixed to the first operating lever at one side with respect to the swing shaft;

an outer shell GND block, comprised of electrically conductive material, and connected to the second operating lever at the one side with respect to the swing shaft so as to be opposed to the board GND block and so as to move in an approaching and separating direction in association with a swing motion of the second operating lever;

a resilient member, provided between the first operating lever and the second operating lever in a contracted manner at the other side with respect to the swing shaft, and resiliently urging in a direction of bringing the outer shell GND block into contact with the board GND block, wherein;

the outer shell GND block is formed with a through hole which extends in the approaching and separating direction and into which an insulating pipe is inserted;

a probe is inserted into the insulating pipe, and one end of the probe is brought into contact with a distal end face of the core conductor;

the outer shell GND of the coaxial connector is fixed to a face of the outer shell GND block at an opposite side to the board GND block to be electrically connected thereto;

an insulating pressure member is provided on a face of the outer shell GND block opposed to the board GND block so the probe which has been inserted into the insulating pipe does not escape in a state where a plunger at the other end of the probe is projected; and

the board GND block is electrically connected to the outer shell GND block.

A linear guide member uprightly provided on the board GND block in the approaching and separating direction may be inserted into a guide hole formed in the outer shell GND block in the approaching and separating direction, whereby the outer shell GND block linearly moves relative to the board GND block in the approaching and separating direction. A connecting member may be connected to a distal end of the second operating lever at the one side and is fixed to the outer shell GND block, and the second operating lever may be connected to the connecting member by means of a second swing shaft which is parallel to the first swing shaft and an elongated hole in a direction substantially perpendicular to the approaching and separating direction into which the second swing shaft is inserted, whereby the outer shell GND block linearly moves in association with the swing motion of the second operating lever.

A leaf spring comprised of electrically conductive material may be fixed to the board GND block, and be brought into resiliently contact with the outer shell GND block so as to slide in the approaching and separating direction, whereby the board GND block is electrically connected to the outer shell GND block.

The insulating pipe into which the probe is inserted may be comprised of material having the same dielectric constant as a dielectric member covering the core conductor of the coaxial connector.

The dielectric member which covers the core conductor of the coaxial connector may be projected from a mounting face of the outer shell GND, and a projected part may be so adapted to be inserted into the through hole which is formed in the outer shell GND block.

A distal end side of the core conductor of the coaxial connector may be inserted into the insulating pipe, and the one end of the probe may be brought into contact with the distal end face of the core conductor, inside the insulating pipe.

A width of the relay connector may be set to be equal to a width of the coaxial connector.

According to the invention, there is also provided a relay connector, comprising:

a conductive first GND block, on which a board both faces of which are formed with a first terminal and a second terminal, respectively, is to be put so that the first terminal is brought in contact with the first GND block;

a conductive second GND block, including a first face facing the first GND block, a second face being opposite to the first face, and a through hole which communicates the first face and the second face and into which a probe is inserted, the probe being insulated from the second GND block; and

a link member, connected to the first GND block and the second GND block, and adapted to cause the second GND block to approach or be separated from the first GND block, wherein

an outer shell GND of a coaxial connector is fixed on the second face of the second GND block; and

a core conductor of the coaxial connector is connected to one end of the probe in the through hole of the second GND block.

The relay connector may further comprise: a urging member, adapted to urge the second GND block toward the first GND block through the link member.

At least when the board is clamped by the first GND block and the second GND block, the other end of the probe may be held in contact with the second terminal of the board, and the first GND block and the second GND block may be connected with each other.

### BRIEF DESCRIPTION OF THE DRAWINGS

FIGS. 1A to 1C show an outer appearance of a relay connector in one embodiment of the invention, in which FIG. 1A is a front view, FIG. 1B is a plan view, and FIG. 1C is a left side view.

FIG. 2 is an exploded perspective view of a part of FIGS. 1A to 1C.

FIG. 3 is a sectional view as seen in a direction of arrow marks A-A on FIG. 1B.

FIG. 4 is a sectional view partly cut away showing a state where a first operating lever and a second operating lever are gripped and a board is inserted.

FIG. 5 is a sectional view partly cut away showing a state where the board is clamped after it has been inserted, by relaxing the grip of the first operating lever and the second operating lever.

FIG. 6 is an enlarged sectional view partly cut away showing a structure of a part where an insulating pipe is arranged.

FIG. 7 is an exploded perspective view of a structure for providing a leaf spring.

FIG. 8 is a sectional view partly cut away showing a relay connector in a second embodiment of the invention.

FIG. 9 is a view showing a structure for electrically connecting related art coaxial connectors to a board.

FIG. 10 is an exploded perspective view showing a state before the related art coaxial connectors are connected to the board.

### DETAILED DESCRIPTION OF PREFERRED EMBODIMENTS

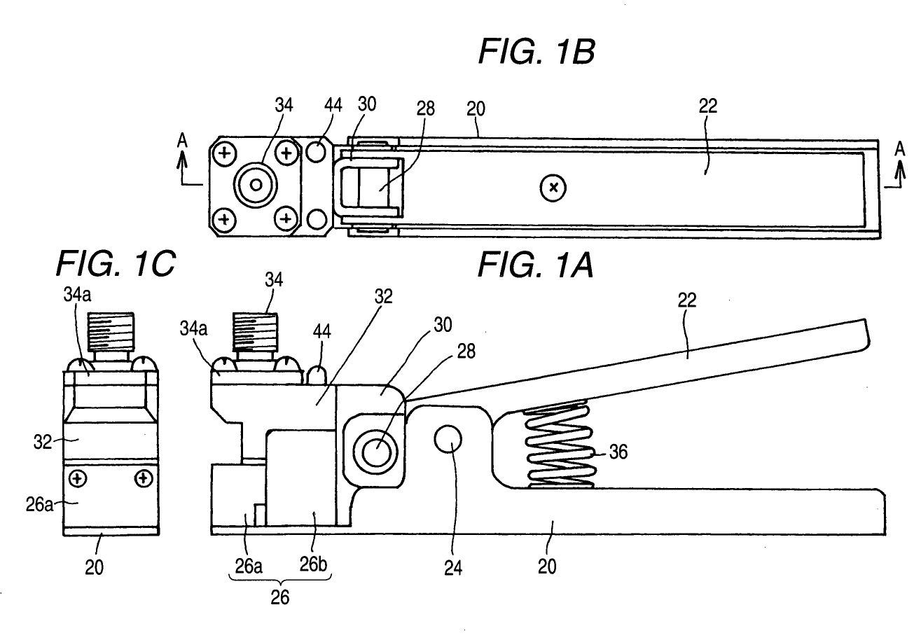

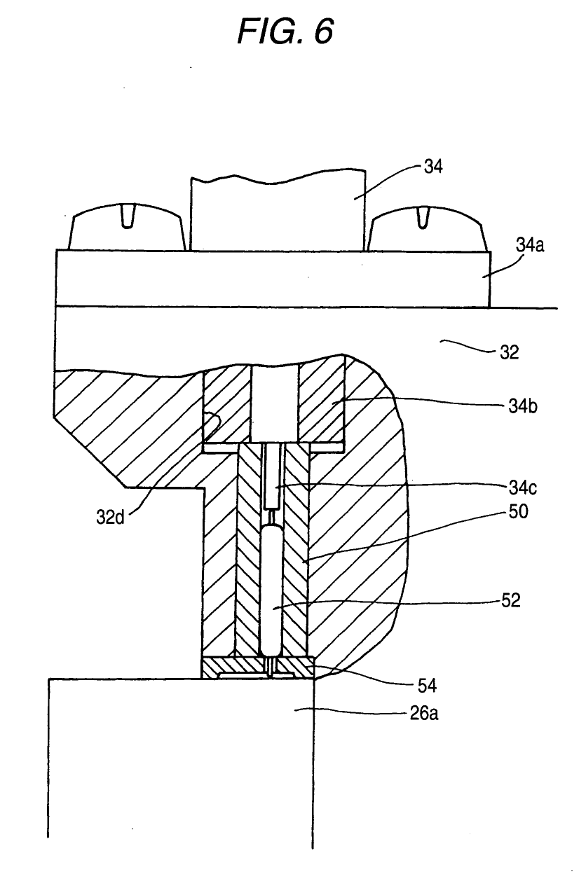

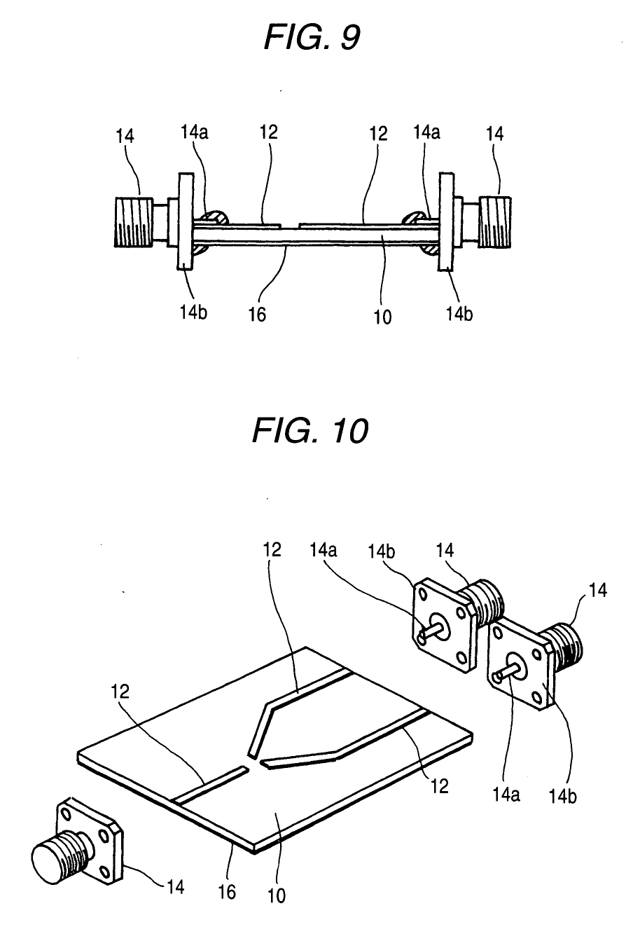

Now, a first embodiment of the invention will be described referring to FIGS. 1A to 7. In FIGS. 1A to 7, the same or equivalent members as in FIGS. 9 and 10 will be denoted with the same reference numerals and overlapping descriptions will be omitted.

In FIGS. 1A to 7, in the relay connector in the first embodiment of the invention, a second operating lever 22 is mounted on a first operating lever 20 by means of a swing shaft 24 so as to swing. A board GND block 26 formed of electrically conductive material is fixed to an end of the first operating lever 20 at one side with respect to the swing shaft 24, with screws. This board GND block 26 includes aboard receiving part 26a and a movement holding part 26b which are fixed to each other with screws. Moreover, a connecting member 30 is connected to an end of the second operating lever 22 at one side with respect to the swing shaft 24, by means of a second swing shaft 28 which is in parallel with the swing shaft 24. An outer shell GND block 32 formed of electrically conductive material is fixed to this connecting member 30. This outer shell GND block 32 is arranged at a position opposed to the board GND block 26. Further, a coaxial connector (an SMA connector, for example) 34 is fixed to a face of the outer shell GND block 32 at an opposite side to the board GND block 26. This coaxial connector 34 includes an outer shell GND 34a which is fixed to the outer shell GND block 32 with screws and electrically connected thereto. Additionally, a resilient spring 36 is provided between the first operating lever 20 and the second operating lever 22 in a contracted state, at the other side with respect to the swing shaft 24, and resiliently urging in a direction of bringing the outer shell GND block 32 into contact with the board GND block 26.

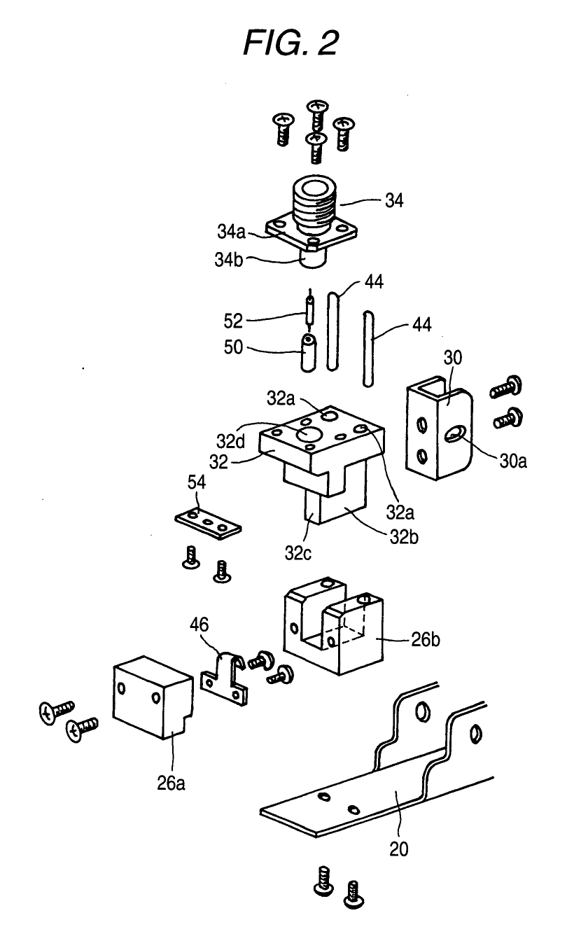

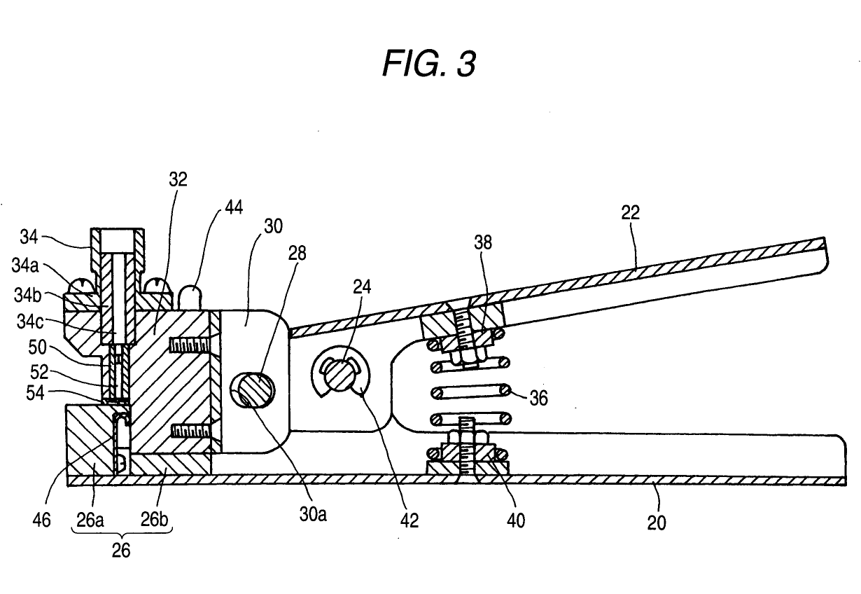

As shown in FIG. 3, spring receiving members 38, 40 are respectively fixed to the first operating lever 20 and the second operating lever 22 with screws and nuts, whereby positions of both ends of the resilient spring 36 are fixed. The swing shaft 24 is restrained from moving in an axial direction, by an E-ring 42 which is provided in a hole formed in the second operating lever 22 having a C-shape in section. The connecting member 30 is formed with an elongated hole 30a into which the second swing shaft 28 is inserted, so that the outer shell GND block 32 can move linearly to approach and separate relative to the board GND block 26, in association with swing motions of the second operating lever 22 relative to the first operating lever 20. In this embodiment, as shown in FIG. 2, linear guide members 44, 44 which are uprightly provided on the movement holding part 26b of the board GND block 26 in an approaching and separating direction of the outer shell GND block 32 are inserted into guide holes 32a, 32a formed in the outer shell GND block 32, the holes passing the block 32 through in the approaching and separating direction. In this manner, the outer shell GND block is so constructed as to linearly move relative to the board GND block 26 in the approaching and separating direction.

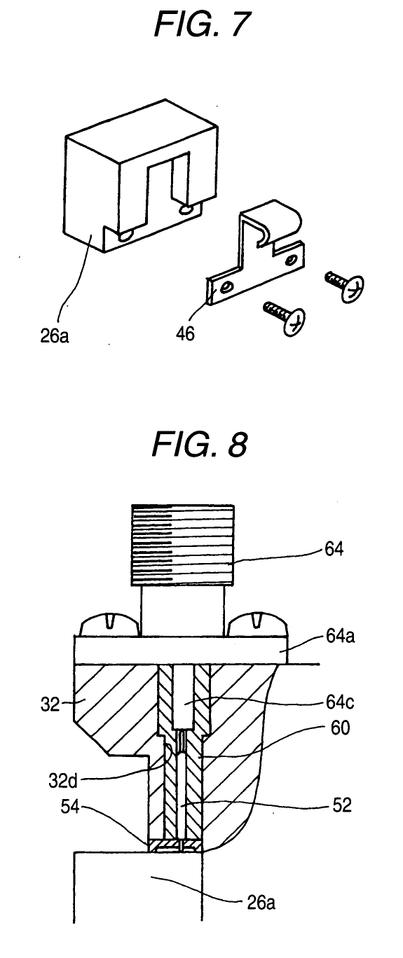

The movement holding part 26b of the board GND block 26 is formed with a groove in a concave shape, and the outer shell GND block 32 is provided with a convex part 32b which can be inserted in and engaged with the concave groove. Moreover, the board receiving part 26a of the board GND block 26 is formed with a dented part which can contain a leaf spring 46 having electrical conductivity, as shown in FIG. 7. The leaf spring 46 is contained in this dented part and fixed with screws. In a state where the leaf spring 46 is fixed, the board receiving part 26a is fixed to the movement holding part 26b. In addition, in the state where the convex part 32b of the outer shell GND block 32 is inserted into the concave groove of the movement holding part 26b, the leaf spring 46 is so adapted as to be resiliently contacted with a front face 32c of the convex part 32b.

Further, the outer shell GND block 32 is formed with a through hole 32d passing it through in the approaching and separating direction. In the state where the dielectric member 34b projecting from the outer shell GND 34a of the coaxial connector 34 is inserted into an open end of the through hole 32d, the coaxial connector 34 is fixed to the outer shell GND block 32 with screws. Further, an insulating pipe 50 formed of material having the same dielectric constant as the dielectric member 34b is inserted into the through hole 32d. A probe 52 having movable plungers at its both ends is inserted into this insulating pipe 50. A distal end portion of a core conductor 34c which is exposed by peeling from the dielectric member 34b is inserted into one end of the insulating pipe 50, in such a manner that the plunger at the one end of the probe 52 is resiliently contacted with a distal end face of the core conductor 34c, inside the insulating pipe 50. Still further, an insulating pressure member 54 formed of insulating material is fixed to a face of the outer shell GND block 32 opposed to the board GND block 26 with screws, so that the probe 52 itself may not escape from the board GND block 26 in a state where the plunger at the other end of the probe 52 is projected. In this embodiment, the plunger at the other end of the probe 52 is so arranged as to be opposed to the board receiving part 26a of the board GND block 26, and a face of the board receiving part 26a which receives a board 10 is formed on a plane perpendicular to an axial direction of the probe 52. It is apparent that the core conductor 34c and the probe 52 are electrically insulated from the outer shell GND block 32. It is to be noted that an inner diameter of the through hole 32d formed in the outer shell GND block 32 is appropriately changed on a halfway of the axial direction. Besides, a width of the relay connector of the invention, that is, a lateral length of the first operating lever 20, the board GND block 26, and the outer shell GND block 32 is set to be equal to a width of the coaxial connector 34, which is 12.7 mm, for example.

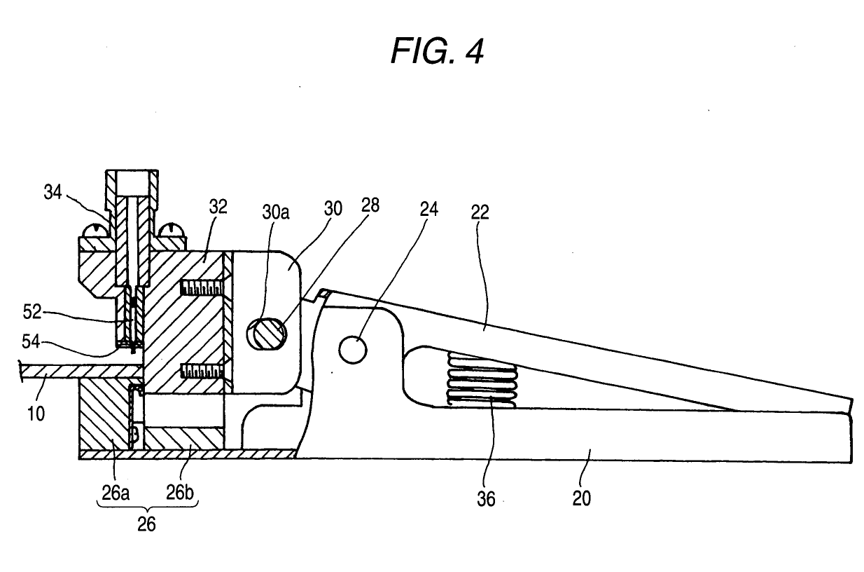

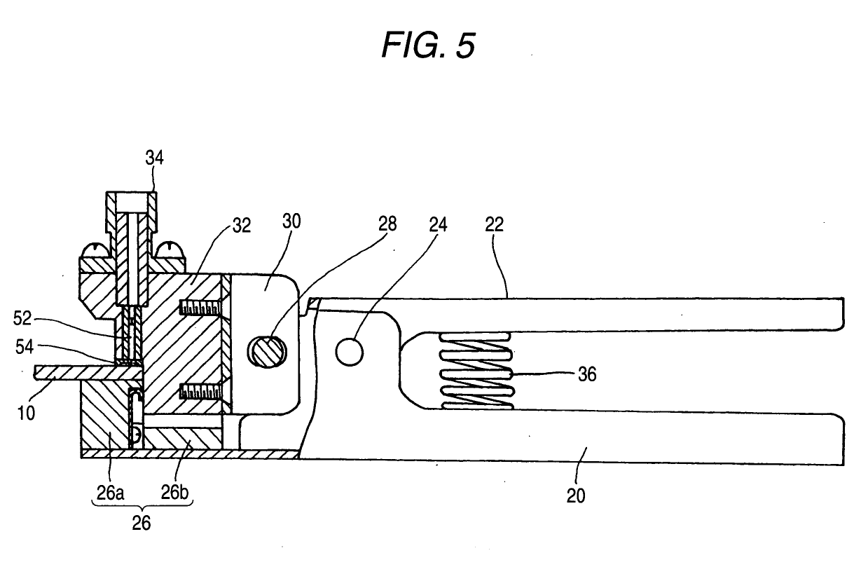

In the above described structure, as shown in FIG. 4, as a first step, the first operating lever 20 and the second operating lever 22 are firmly gripped against resilience of the resilient spring 36, whereby the outer shell GND block 32 is separated from the board GND block 26, and a gap is formed between the board receiving part 26a and the insulating pressure member 54. Then, the board 10 is inserted into this gap and positioned so that the plunger of the probe 52 may be opposed to the terminal electrode 12. In this state, by relaxing the grip of the first operating lever 20 and the second operating lever 22, as shown in FIG. 5, the board 10 is clamped between the board receiving part 26a and the insulating pressure member 54 with the resilience of the resilient spring 36. Then, the plunger of the probe 52 is resiliently brought into contact with the terminal electrode 12 of the board 10, whereby the terminal electrode 12 is electrically connected to the core conductor 34c of the coaxial connector 34. Moreover, the GND electrode 16 of the board 10 is electrically connected to the board receiving part 26a, since it is mounted on the board receiving part 26a, and further, electrically connected to the outer shell GND 34a of the coaxial connector 34 by way of the leaf spring 46 and the outer shell GND block 32 connected in series. In this manner, by gripping the first operating lever 20 and the second operating lever 22 to clamp the board 10, the terminal electrode 12 and the GND electrode 16 of the board 10 can be electrically connected to the coaxial connector 34 easily. Then, by gripping the first operating lever 20 and the second operating lever 22 again, the board 10 which has been clamped can be easily detached. In addition, because the width of the relay connector according to the invention is set to be equal to the width of the coaxial connector 34, it is possible to arrange a plurality of the relay connectors according to the invention on the board 10, at the maximum density that the coaxial connectors 34 can be arranged in parallel in the lateral direction.

Now, a second embodiment of the invention will be described referring to FIG. 8. In FIG. 8, the same or equivalent members as in FIGS. 1A to 7 will be denoted with the same reference numerals and overlapped descriptions will be omitted.

In the relay connector in the second embodiment of the invention, a dielectric member covering a core conductor 64c of a coaxial connector 64 is not projected from an outer shell GND 64a, but only the core conductor 64c exposed by peeling from the dielectric member is projected. Therefore, an insulating pipe 60 is inserted into the through hole 32d in the outer shell GND block 32 along an entire length of the through hole 32d, and the core conductor 64c projected from the outer shell GND 64a is inserted into one end of the insulating pipe 60. A plunger at one end of the probe 52 which is inserted into the insulating pipe 60 is so adapted as to be resiliently contacted with a distal end face of the core conductor 64c, inside the insulating pipe 60. An inner diameter and an outer diameter of the insulating pipe 60 in this second embodiment are appropriately changed in the axial direction.

A mechanism for restricting the linear movement of the outer shell GND block 32 relative to the board GND block 26 in the approaching and separating direction is not limited to the structure in the above described embodiments, but it is possible to appropriately form the mechanism using a dovetail groove or the like. A mechanism for linearly moving the outer shell GND block 32 by swinging the second operating lever 22 relative to the first operating lever 20 too is not limited to the structure in the above described embodiments, but may be formed employing an appropriate link mechanism. Moreover, a structure for electrically connecting the board receiving part 26a, on which the GND electrode 16 of the board 10 is mounted, to the outer shell GND block 32 is not limited to the structure using the leaf spring 46 in the above described embodiment, but they may be connected by a flexible electric wire. Any structure can be employed provided that reliable electrical connection can be obtained. Further, the probe 52 is not limited to such a structure that movable plungers are provided at both ends, but a probe having a movable plunger at one end can be also used. Still further, the resilient member which is provided between the first operating lever 20 and the second operating member 22 in a contracted state is not limited to the resilient spring 36 in the above described embodiments, but a plate-like spring may be employed.

According to an aspect of the invention, by gripping the first operating lever and the second operating lever against resilience of the resilient member to form a gap between the board GND block and the outer shell GND block, and by relaxing the grip after the board has been inserted into this gap, the board is clamped between the board GND block and the outer shell GND block, whereby the core conductor of the coaxial connector is brought into contact with the terminal electrode provided on the surface of the board by way of the probe, and the outer shell GND is brought into contact with the GND electrode provided on the back face of the board to be electrically connected respectively. Then, by gripping the first operating lever and the second operating lever again against the resilience of the resilient member, the board GND block is separated from the outer shell GND block, and the board is detached. Accordingly, it is possible to electrically connect the board to the coaxial connector easily, and to detach it easily.

Moreover, the outer shell GND block can move linearly relative to the board GND block in the approaching and separating direction by the swing motion of the second operating lever. Therefore, the outer shell GND block moves relative to the board in the perpendicular direction, and it will not occur that the probe in contact with the terminal electrode on the board may be displaced sideward and broken.

Although the outer shell GND block moves relative to the board GND block in the approaching and separating direction, the leaf spring formed of electrically conductive material is resiliently contacted with the outer shell GND block so as to slide. Therefore, the electrical connection between the board GND block and the outer shell GND block can be reliably performed.

The insulating pipe into which the probe is inserted is formed of the material having the same dielectric constant as the dielectric member which covers the core conductor of the coaxial connector. Therefore, it is easy to set the impedance from the core conductor to the probe at the same value.

The dielectric member which covers the core conductor of the coaxial connector is projected from the mounting face of the outer shell GND, and the projected part is so adapted to be inserted into the through hole which is formed in the outer shell GND block. Therefore, the projected part of the dielectric member which covers the core conductor can be easily formed in the coaxial structure, and at the same time, the coaxial connector can be easily and reliably positioned with respect to the outer shell GND block.

The distal end side of the core conductor of the coaxial connector is inserted into the insulating pipe so that one end of the probe may be contacted with the distal end face of the core conductor inside the insulating pipe. Therefore, it is possible to reliably bring the one end of the probe into contact with the distal end face of the core conductor with a simple structure.

The width of the relay connector is set to be equal to the width of the coaxial connector. Therefore, a plurality of the relay connectors according to the invention can be arranged on the board at the maximum density that the coaxial connectors can be arranged on the board.

What is claimed is:

1. A relay connector for electrically connecting a core conductor of a coaxial connector to a terminal electrode provided at an end of a surface of a board, and for electrically connecting an outer shell GND of the coaxial connector to a GND electrode provided at an end of a back face of the board, the relay connector comprising:
a first operating lever;
a second operating lever, provided on the first operating lever so as to swing by means of a first swing shaft;
a board GND block, comprised of electrically conductive material, and fixed to the first operating lever at one side with respect to the swing shaft;
an outer shell GND block, comprised of electrically conductive material, and connected to the second operating lever at the one side with respect to the swing shaft so as to be opposed to the board GND block and so as to move in an approaching and separating direction in association with a swing motion of the second operating lever;
a resilient member, provided between the first operating lever and the second operating lever in a contracted manner at the other side with respect to the swing shaft, and resiliently urging in a direction of bringing the outer shell GND block into contact with the board GND block, wherein:
the outer shell GND block is formed with a through hole which extends in the approaching and separating direction and into which an insulating pipe is inserted;
a probe is inserted into the insulating pipe, and one end of the probe is brought into contact with a distal end face of the core conductor;
the outer shell GND of the coaxial connector is fixed to a face of the outer shell GND block at an opposite side to the board GND block to be electrically connected thereto;
an insulating pressure member is provided on a face of the outer shell GND block opposed to the board GND block so the probe which has been inserted into the insulating pipe does not escape in a state where a plunger at the other end of the probe is projected; and
the board GND block is electrically connected to the outer shell GND block.

2. The relay connector as claimed in claim 1, wherein
a linear guide member uprightly provided on the board GND block in the approaching and separating direction is inserted into a guide hole formed in the outer shell GND block in the approaching and separating direction, whereby the outer shell GND block linearly moves relative to the board GND block in the approaching and separating direction,
a connecting member is connected to a distal end of the second operating lever at the one side and is fixed to the outer shell GND block, and the second operating lever is connected to the connecting member by means of a second swing shaft which is parallel to the first swing shaft and an elongated hole in a direction substantially perpendicular to the approaching and separating direction into which the second swing shaft is inserted,
whereby the outer shell GND block linearly moves in association with the swing motion of the second operating lever.

3. The relay connector as claimed in claim 1, wherein
a leaf spring comprised of electrically conductive material is fixed to the board GND block, and is brought into resiliently contact with the outer shell GND block so as to slide in the approaching and separating direction, whereby the board GND block is electrically connected to the outer shell GND block.

4. The relay connector as claimed in claim 1, wherein
the insulating pipe into which the probe is inserted is comprised of material having the same dielectric constant as a dielectric member covering the core conductor of the coaxial connector.

5. The relay connector as claimed in claim 1, wherein
the dielectric member which covers the core conductor of the coaxial connector is projected from a mounting face of the outer shell GND, and a projected part is so adapted to be inserted into the through hole which is formed in the outer shell GND block.

6. The relay connector as claimed in claim 1, wherein
a distal end side of the core conductor of the coaxial connector is inserted into the insulating pipe, and the one end of the probe is brought into contact with the distal end face of the core conductor, inside the insulating pipe.

7. The relay connector as claimed in claim 1, wherein
a width of the relay connector is set to be equal to a width of the coaxial connector.

8. A relay connector, comprising:
a conductive first GND block, on which a board both faces of which are formed with a first terminal and a second terminal, respectively, is to be put so that the first terminal is brought in contact with the first GND block;
a conductive second GND block, including a first face facing the first GND block, a second face being opposite to the first face, and a through hole which communicates the first face and the second face and into which a probe is inserted, the probe being insulated from the second GND block; and
a link member, connected to the first GND block and the second GND block, and adapted to cause the second GND block to approach or be separated from the first GND block, wherein
an outer shell GND of a coaxial connector is fixed on the second face of the second GND block; and
a core conductor of the coaxial connector is connected to one end of the probe in the through hole of the second GND block.

9. The relay connector as claimed in claim 8, further comprising:
a urging member, adapted to urge the second GND block toward the first GND block through the link member.

10. The relay connector as claimed in claim 8, wherein
at least when the board is clamped by the first GND block and the second GND block, the other end of the probe is held in contact with the second terminal of the board, and the first GND block and the second GND block are connected with each other.
